(19) United States
(12) Patent Application Publication
(10) Pub. No.: US 2025/0058626 A1
(43) Pub. Date: Feb. 20, 2025

(54) METHOD AND CONTROL ARRANGEMENT FOR TRANSFERRING A POWER BETWEEN ELECTRIC MACHINES IN A VEHICLE

(71) Applicant: Scania CV AB, Södertälje (SE)

(72) Inventors: Daniel Ståhl, Enköping (SE); Magnus Carlgren, Vagnhärad (SE); Joar Turesson, Göteborg (SE)

(73) Assignee: Scania CV AB, Södertälje (SE)

(21) Appl. No.: 18/794,213

(22) Filed: Aug. 5, 2024

(30) Foreign Application Priority Data
Aug. 17, 2023 (SE) 2350974-8

(51) Int. Cl. B60K 23/08; B60K 1/02; B60K 17/10; B60L 15/20

(52) U.S. Cl. CPC B60K 23/0808; B60K 1/02; B60K 17/10; B60L 15/20; B60L 2240/421; B60L 2240/465; B60L 2240/642; B60L 2250/28; B60L 2260/20

(57) ABSTRACT

A method performed by a control arrangement for powering a vehicle, the vehicle comprising at least one first electric machine configured to provide a power to a first vehicle wheel, and at least one second electric machine configured to provide a power to a second vehicle wheel. The at least one first electric machine and the at least one second electric machine in the vehicle are interconnected by means of a hydraulic connection which enables the utilization of the available power from the electric machines by transferring excess power provided by one or more electric machines to a drive wheel or axle where additional power is required. The invention also relates also to a control arrangement, a vehicle comprising the control arrangement, and a computer program.

### CROSS-REFERENCE TO RELATED APPLICATIONS

This application claims priority to Swedish Patent Application No. 2350974-8 filed Aug. 17, 2023, of the same title; the contents of which are hereby incorporated by reference.

### TECHNICAL FIELD

The invention relates to a method and a control arrangement for transferring a power between electric machines in a vehicle. The invention also relates to a computer program and a computer-readable medium and a vehicle comprising such a control arrangement.

### BACKGROUND

The following background description constitutes a description of the background to the invention, which does not, however, necessarily have to constitute prior art.

A vehicle must be able to be driven safely and reliably under varying road conditions. Some electric vehicles, such as trucks, and busses, are equipped with separate drivelines, which may provide certain advantages such as improved traction, enhanced maneuverability, and increased power distribution flexibility. By having separate drivelines, power can be directed to each axle or each wheel of the vehicle independently, allowing for better traction control and optimized power delivery to the wheels with grip. This setup may also enhance the vehicle's maneuverability, as power can be distributed selectively to specific wheels or axles, enabling improved handling in different driving scenarios. Additionally, separate drivelines offer flexibility in power distribution, allowing adjustments to be made based on varying road conditions and driving demands.

### SUMMARY

It is an objective of the present invention to provide methods and control arrangements for mitigating or solving drawbacks of conventional solutions.

According to a first aspect of the invention, aforementioned and further objectives are achieved through a method for powering a vehicle, the vehicle comprising at least one first electric machine configured to provide a power to a first vehicle wheel, and at least one second electric machine configured to provide a power to a second vehicle wheel, wherein the at least one first electric machine and the at least one second electric machine are interconnected by means of a hydraulic connection, the method comprising, for at least one vehicle driving condition:
transferring a power between the at least one first electric machine and the at least one second electric machine by means of the hydraulic connection.

It is to be understood that the at least one first electric machine and the at least one second electric machine may be used to provide power to one or more vehicle drive wheels and/or to one or more power consumers in the vehicle depending on the vehicle configuration as will be explained further on. The at least one vehicle driving condition may be a condition indicating that excess power is available in one or more electric machines and at the same time additional power is required to operate the vehicle to achieve a required performance. The vehicle driving condition may for example be a condition indicating that additional power might be required to propel the vehicle according to a required speed. The additional power may be a propelling power or a braking power. For example, the maximum power that may be provided by an electric machine to a first vehicle drive wheel or axle may not be enough to start the vehicle or to operate the vehicle at a required speed when such driving condition is present. At the same time excess power may be available in another electric machine, e.g., an electric machine powering a second vehicle drive wheel having a limited force e.g., due to being located on a low friction road surface. The vehicle driving condition may, for example relate to an inclined road section, a slippery road section or to uneven load on the vehicle drive wheels.

Conventionally, when the vehicle is powered by a single electric machine or a plurality of mechanically interconnected electric machines, and when such a driving condition is detected, the provided power may be redistributed between vehicle wheels or axles to enhance the performance of the vehicle. However, in configurations where no such mechanical connection between the electric machines is available, for example on vehicles with more than one driven axles driven by separate propulsion units, the vehicle's maximum power may not be possible to utilize resulting in deteriorated vehicle performance.

According to the invention, the electric machines in the vehicle are interconnected by means of a hydraulic connection which enables the utilization of the available power from the hydraulically interconnected electric machines by transferring excess power provided by one or more electric machines to a drive wheel or axle where additional power is required. Hereby, improved performance of the vehicle may be achieved.

In an embodiment of the invention, the vehicle driving condition occurs when the grip of the first vehicle wheel differs from the grip of the second vehicle wheel, the method further comprising:
transferring power from the at least one first electric machine to the at least one second electric machine when the grip of the second vehicle wheel exceeds the grip of the first vehicle wheel, and vice versa.

It is to be understood that the grip of a vehicle wheel corresponds to the measure of how well the wheel maintains its grip on the surface while in motion. Wheel grip is crucial for the performance of a vehicle as it directly affects its ability to accelerate, decelerate, and maneuver effectively. When a wheel has good grip, it means that it can maintain traction with the surface, allowing it to transfer the necessary forces for propulsion, braking, and steering.

Factors that can influence wheel grip include the nature of the surface, such as rough, smooth, dry, wet, etc., the condition of the wheel, i.e., the tire quality, tread depth, tire pressure, and the external forces acting upon the wheel, e.g., load of the vehicle.

Uneven grip on vehicle wheels can arise for example when the above-mentioned factors differ for different wheels. For example, the load on the vehicle wheels may be uneven or parts of the surface of the road section on which the vehicle is travelling may be slippery. Such uneven grip on vehicle wheels can affect the handling, performance, and safety of the vehicle.

Some potential consequences of uneven grip involve reduced traction on certain wheels which may result in reduced acceleration and brake performance of the vehicle. Furthermore, the wheels with better grip may experience excessive wear and tear, while the wheels with poor grip may wear less. This can result in the need for premature tire replacement and can also affect the vehicle's overall balance.

By transferring power from the at least one first electric machine to the at least one second electric machine when the grip of the second vehicle wheel exceeds the grip of the first vehicle wheel, and vice versa, more power will be transferred to the wheel having better grip. Hereby, the vehicle's energy usage is optimized by minimizing unnecessary wheel slip or spin. This can lead to improved energy efficiency and increased electric range in hybrid or electric vehicles.

Moreover, the vehicle may be dimensioned with smaller electric machines compared to traditional drivetrain configurations. This is because the invention allows for a more precise control over the distribution of total power in the vehicle to individual wheels/axles, which can compensate for the reduced power output of smaller electric machines. This can contribute to cost savings during the production of the vehicle and reduce the overall weight of the vehicle. Lighter vehicles often have improved energy efficiency and handling. They may also require less energy to operate, which can extend the vehicle's range.

In an embodiment of the invention, the first vehicle wheel and the second vehicle wheel are located on a common vehicle axle.

This means that the power generated by the at least one first electric machine and the at least one second electric machine may be distributed between the wheels on the same axle such that more power is applied to the wheel with higher grip to maximize the traction. By applying more power to the wheels with higher grip or to the wheel that require more power, may improve the stability, and performance of the vehicle, especially in challenging road conditions, such as wet or slippery surfaces. This can enhance driving safety and confidence.

In an embodiment of the invention, the first vehicle wheel is a wheel of a first vehicle axle of the vehicle, and the second vehicle wheel is a wheel of a second vehicle axle.

It is to be understood that the first and the second vehicle axle connects and supports the wheels on opposite sides of a vehicle. There are different types of axles used in vehicles, depending on the vehicle's configuration. Thus, the first and the second vehicle axle may be a vehicle axle such as a front axle supporting the front wheels of the vehicle, a rear axle supporting the rear wheels of the vehicle, an axle on a trailing vehicle, a retractable vehicle axle, and/or a driven e-axle receiving torque from one or more electric machines in the vehicle.

This means that the power generated by the at least one first electric machine and the at least one second electric machine may be distributed between different axles of the vehicle to improve the stability, and performance of the vehicle.

In an embodiment of the invention, the first vehicle axle is mechanically separated from the second vehicle axle.

The first vehicle axle being mechanically separated from the second vehicle means that no power can be mechanically transferred between the first vehicle axle and the second vehicle axle. Thus, conventional torque vectoring between different axles is not possible. The invention makes it possible to distribute the power generated by the at least one first electric machine and the at least one second electric machine between different vehicle axles. Hereby, the stability, and performance of the vehicle is improved also in vehicle configurations where such distribution is not otherwise possible.

In an embodiment of the invention, the at least one first electric machine is mechanically separated from the at least one second electric machine.

It is to be understood that the at least one first electric machine is mechanically separated from the at least one second electric machine such that no power can be mechanically transferred between the separated electric machines.

The invention makes it possible to distribute the power generated by the at least one first electric machine and the at least one second electric machine between different vehicle wheels and/or axles without a mechanical connection for transferring power. Hereby, the stability, and performance of the vehicle is improved also in vehicle configurations where such distribution is not otherwise possible.

In an embodiment of the invention, the at least one first electric machine and/or the at least one second electric machine is configured to power a Power Take-Off, PTO, by means of a hydraulically connected PTO, and wherein the vehicle driving condition comprises a PTO power request, the method further comprising:

transferring power from the at least one first electric machine or the at least one second electric machine to the hydraulically connected PTO.

This means that a PTO can be powered by any of the electric machines in the vehicle having an excess power. Hereby an efficient, flexible, and reliable PTO power supply is provided.

In an embodiment of the invention, the magnitude of power transferred from the at least one first electric machine and/or the at least one second electric machine over the hydraulic connection is based on one or more parameters related to the vehicle driving condition.

Hereby, the power generated in the at least one first electric machine and the at least one second electric machine may be managed in an efficient and reliable manner.

In an embodiment of the invention, the parameters related to the vehicle driving condition comprise:
a rotational speed of the at least one first electric machine and/or the at least one second electric machine,
a wheel slip of the first vehicle wheel and/or the second vehicle wheel,
a weight of the vehicle,
an inclination of an approaching road section,
a rate or a rate of change of an acceleration request,
an available power that may be transferred between the vehicle and the road,
a vehicle drive mode,
a road condition of the coming road section,
a vehicle steering angle,
a load on the vehicle axles of the vehicle, and/or
a power request to a PTO connected to the at least one first electric machine and/or the at least one second electric machine.

Such parameters, i.e., vehicle related parameter and/or parameters related to the approaching road section may be obtained in the vehicle according to conventional solutions. Hereby, the occurrence of the vehicle driving condition may be determined in an efficient and reliable way.

In an embodiment of the invention, the method further comprises:
disconnecting the at least one first electric machine from the first vehicle wheel and/or the at least one second electric machine from the second vehicle wheel prior to transferring power from the disconnected electric machine over the hydraulic connection.

Hereby, the excess power may be efficiently transferred from an electric machine also when no power is to be transmitted to the vehicle wheel which the electric machine is configured to provide a power to.

In an embodiment of the invention, one or both of the at least one first and at least one second electric machine is configured to power a hydraulic pump for providing hydraulic fluid to a hydraulic motor connected to the wheel driven by the other of the at least one first and at least one second electric machine to thereby transfer power from the one of the at least one first and at least one second electric machine to the other.

Hereby, power may be transferred by means of the hydraulic connection from or to one or both of the at least one first and at least one second electric machine.

According to a second aspect, the invention relates to a control arrangement for powering a vehicle, the vehicle comprising at least one first electric machine configured to provide a power to a first vehicle wheel, and at least one second electric machine configured to provide a power to a second vehicle wheel, wherein the at least one first electric machine and the at least one second electric machine are interconnected by means of a hydraulic connection, the control arrangement being configured to, for at least one vehicle driving condition:

transferring a power between the at least one first electric machine and the at least one second electric machine by means of the hydraulic connection.

It will be appreciated that all the embodiments described for the method aspects of the invention are applicable also to at least one of the control arrangement aspects of the invention. Thus, all the embodiments described for the method aspects of the invention may be performed by the control arrangement, which may also be a control device, i.e. a device. The control arrangement and its embodiments have advantages corresponding to the advantages mentioned above for the methods and their embodiments.

According to a third aspect of the invention, aforementioned and further objectives are achieved through a vehicle comprising the control arrangement of the second aspect. According to a fourth aspect, the invention relates to a computer program comprising instructions which, when the program is executed by a computer, cause the computer to carry out the method according to the first aspect.

According to a fifth aspect, the invention relates to a computer-readable medium comprising instructions which, when executed by a computer, cause the computer to carry out the method according to the first aspect.

### BRIEF DESCRIPTION OF THE DRAWINGS

Embodiments of the invention will be illustrated in more detail below, along with the enclosed drawings, where similar references are used for similar parts, and where:

FIG. 1a shows an example vehicle, in which embodiments of the invention may be implemented.

FIG. 1b shows a vehicle configuration in which embodiments of the invention may be implemented.

FIG. 1c shows a further vehicle configuration in which embodiments of the invention may be implemented.

FIG. 2a shows a flow chart of a method for controlling an electric powertrain of a vehicle in a freewheeling state according to embodiments of the invention.

FIG. 2b shows a flow chart of a method for controlling an electric powertrain of a vehicle in a freewheeling state according to further embodiments of the invention.

FIG. 3 shows an example of power transfer between electric machines in a vehicle according to embodiments of the invention.

FIG. 4a shows an example of power transfer actuated based on the difference in slip of the vehicle drive wheels according to embodiments of the invention.

FIG. 4b shows an example of power transfer actuated based on the difference in the rotational speed of the electric machines in a vehicle according to embodiments of the invention.

FIG. 5 shows a control arrangement, in which a method according to any one of the herein described embodiments may be implemented.

### DETAILED DESCRIPTION

Commonly, in electric vehicles it is advantageous to be able to distribute the power produced in the vehicle to avoid costly over-dimensioning of the vehicle's power supply. For example, if one wheel or one axle lacks grip or has very little traction, it would be desirable in certain cases, to transfer more power to the wheel or axle that has grip. In applications where grip is sometimes limited, torque may be distributed to the wheel or axle with most grip using difflocks, torque vectoring or braking individual wheels. On a vehicle with more than one driven axle, an inter-axle difflock is often used to transfer power to all wheels and thereby maximizing traction force.

On electric vehicles driven by separate electric machines, the vehicle's maximum propulsion power is sometimes not possible to utilize. If one axle lacks friction, the electric machine supplying power to this axle has no way to transfer power to an axle or a wheel with higher grip unless there is a mechanical connection between that electric machine and the axle or wheel with higher grip. The possibility to have such a mechanical connection for power transfer is sometimes limited due to factors such as a large axle distance, lack of space in the vehicle chassis, or other axle configuration limitations.

It is therefore an objective of the present invention to provide a method and a control arrangement for powering a vehicle such that these problems are at least partly solved.

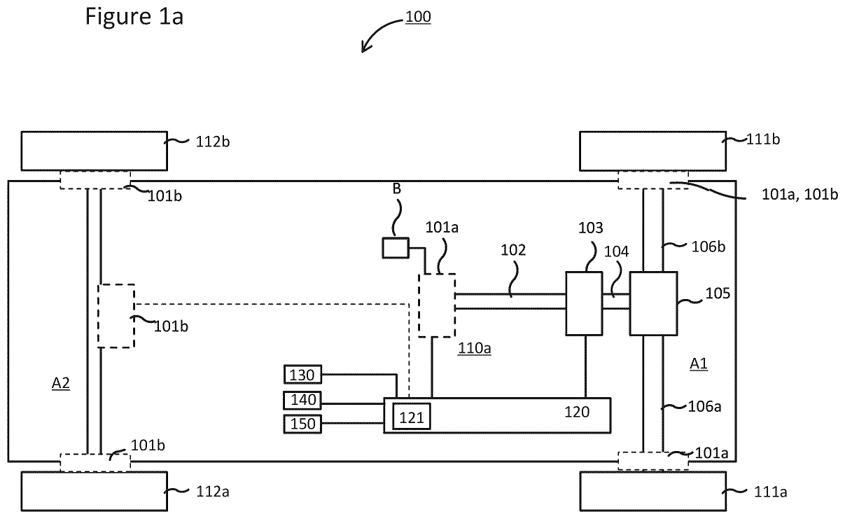

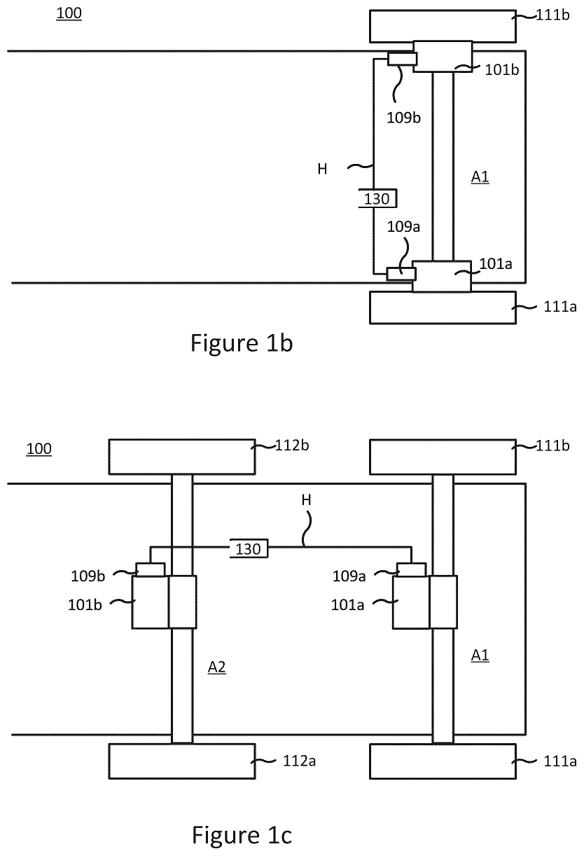

FIG. 1a, which will be used to explain the herein presented embodiments, shows a vehicle 100. The vehicle 100 may be an electric vehicle such as, e.g., a truck or a bus. Although not illustrated in FIG. 1a, the vehicle 100 may be equipped with a trailer. The vehicle may alternatively be a car. The vehicle 100 illustrated in FIG. 1a may comprise a powertrain 110a, configured for an electric vehicle such as a battery electric vehicle. The powertrain may comprise an electric motor system comprising at least one first electric machine 101a and may be configured for applying a propulsive power and/or a regenerative power e.g., to provide torque to one or more wheels 111a, 111b of the vehicle 100. It is to be understood that the vehicle 100 may comprise fewer or more wheels than what is shown in FIG. 1a. The at least one first electric machine 101a may, in a conventional way, be connected to at least one energy storage B configured to provide the at least one first electric machine 101a with electric power.

The at least one first electric machine 101a may be arranged essentially anywhere, as long as torque is provided to one or more of the wheels of the vehicle.

The at least one first electric machine 101a may, for example, be in a conventional manner connected via an output shaft 102 to a gearbox 103 via an input shaft of the gearbox 103. A propeller shaft 104, connected to an output shaft of the gearbox 103, drives the drive wheels 111a, 111b via a vehicle axle A1 connecting and supporting the drive wheels 111a, 111b of the vehicle 100. The vehicle axle A1 comprises a central gear 105 and drive shafts 106a, 106b. The central gear 105, such as e.g. a customary differential, is connected to the propeller shaft 104 distributing power to the drive shafts 106a, 106b. A power provided by the at least one first electric machine 101a is thus transmitted to the drive wheels 111a, 111b. It should be understood that the vehicle 100 may be arranged in any known way, for example without a conventional differential, and/or the gearbox without limiting the scope of the invention. The vehicle may be configured with one or more drive axles, each driven axle may be powered separately by one or more electric machines.

Moreover, the at least one first electric machine 101a may be arranged essentially anywhere along the powertrain 110a, as long as torque is provided to one or more of the wheels, e.g., configured as a hub motor integrated directly into and providing individual power to a vehicle wheel 111a, 111b.

Furthermore, the vehicle may comprise at least one second electric machine 101b and/or be configured with at least one additional powertrain comprising the at least one second electric machine 101b as will be explained with reference to FIGS. 1b and 1c.

The vehicle may further comprise a Power Take-Off, PTO, 130, configured to, when coupled to a power source, transfer power from the power source to another piece of equipment (not illustrated), as will be explained in more detail in this disclosure. The power source providing power to the PTO may be an electric machine, such as the above described electric machine 101a, or a further electric machine. The PTO may be powered by means of a hydraulic connection, connecting the PTO with one or more electric machines.

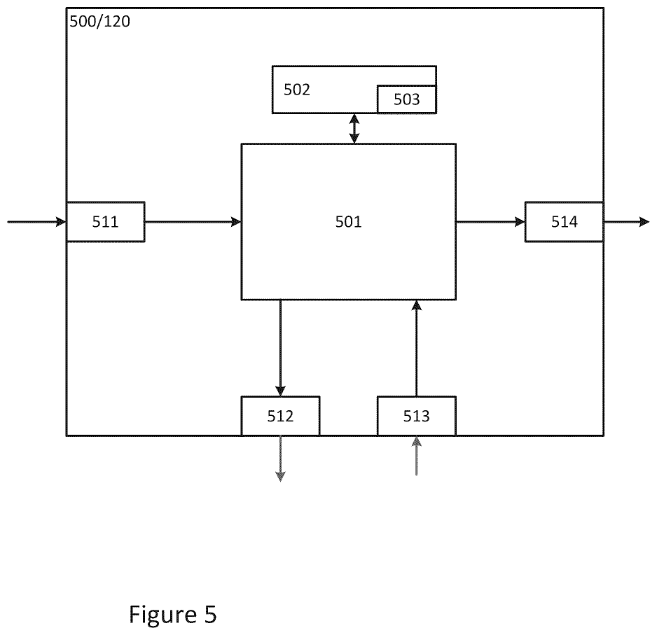

The components of the powertrain 110 of the vehicle 100, as well as other components in the vehicle 100 may be controlled by a vehicle control system via a control arrangement 120. The control arrangement 120 may be distributed on several control units configured to control different parts of the vehicle 100. The control arrangement 120 may e.g. include a unit 121 for transferring a power between at least one first electric machine and at least one second electric machine in the vehicle by means of the hydraulic connection, as well as other units arranged for performing the method steps of the disclosed invention as is explained further on. The control arrangement 120 will be described in further detail in conjunction with FIG. 5.

The vehicle 100 may further include one or more sensors 140 providing sensor data to the vehicle control system, e.g., sensors for measuring the weight of the vehicle 100, the rotational speed of the one or more electric machines in the vehicle, a wheel slipe of one or more wheels of the vehicle 100, to mention a few. Further, the vehicle 100 may comprise a positioning system/unit 150. The positioning unit 150 may be based on a satellite navigation system such as the Navigation Signal Timing and Ranging (Navstar), Global Positioning System (GPS), Differential GPS (DGPS), Galeo, GLONASS, or the like. Thus, the positioning unit 150 may comprise a GPS receiver. It is to be understood that the above mentioned one or more sensors 140 and positioning system/unit 150 may be configured for communication with the control arrangement 120 to provide the control arrangement 120 with relevant information.

It is to be understood that the vehicle 100 may include further units, components, such as electrical and/or mechanical components not illustrated in FIG. 1a. The vehicle 100 may for example be configured and comprise means necessary for communication with another external entity, e.g., by means of a vehicle-to-vehicle V2V communication, a vehicle-to-infrastructure V2I communication, a vehicle-to-everything V2X communication. However, in FIG. 1a, only the units/devices/entities of the vehicle 100 required for understanding the present invention are illustrated.

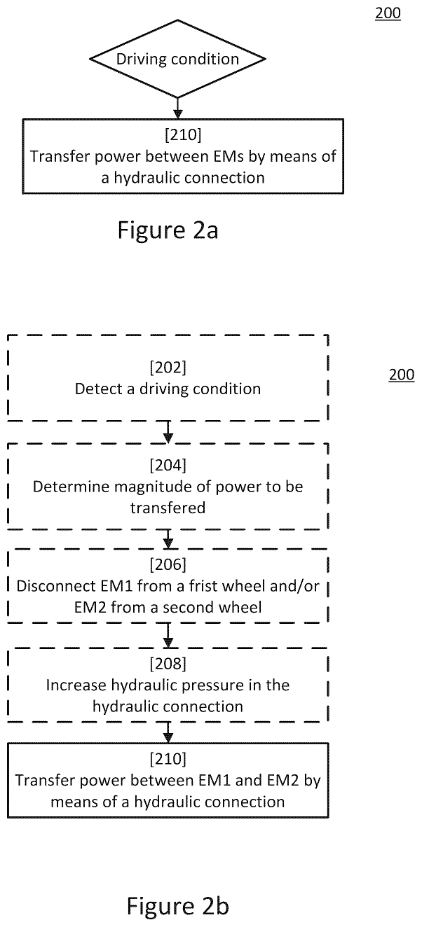

The proposed solution will now be described with reference to a method 200 disclosed in FIG. 2a and the vehicle 100 disclosed in FIG. 1a. FIG. 2a illustrates a flow chart of the method 200 for powering a vehicle 100, the vehicle 100 comprising at least one first electric machine 101a configured to provide a power to a first vehicle wheel 111a, and at least one second electric machine 101b configured to provide a power to a second vehicle wheel 111b, 112a, 112b, wherein the at least one first electric machine 101a and the at least one second electric machine 101b are interconnected by means of a hydraulic connection.

The method comprises, for at least one vehicle driving condition in step 210 transferring a power between the at least one first electric machine 101a and the at least one second electric machine 101b by means of the hydraulic connection.

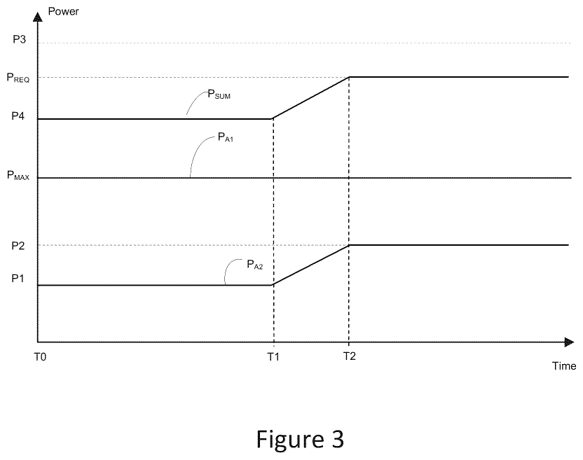

By transferring the power between the electric machines 101a, 101b, the invention aims to increase the total power provided to the vehicle drive wheels during a driving condition when such total power is otherwise limited as is explained with reference to FIG. 3.

FIG. 3 illustrates an example of a power transfer between electric machines in a vehicle 100 according to the method 200 of the invention. In the non-limiting example illustrated in FIG. 3 the power transfer is performed between at least one first electric machine 101a providing power to a first driven axle A1 and/or to a first wheel and at least one second electric machine 101b providing power to a second driven axle A2 and/or to a second wheel. FIG. 3 shows a plot P_{A1} corresponding to the power applied over time by the at least one first electric machine 101a, a plot P_{A2} corresponding to the power applied over time by the at least one second electric machine 101b, and a plot P_{SUM} corresponding to the total power applied over time by the at least one first and the at least one second electric machine 101a, 101b. Thus, in FIG. 3 P_{SUM}=P_{A1}+P_{A2}.

Moreover, FIG. 3 shows the power level P_{REQ} corresponding to the minimum total power required for propulsion or braking of the vehicle 100. The required minimum power P_{REQ} may for example be a power required to overcome a total driving resistance and/or to maintain a certain speed profile, or a power required to start or brake the vehicle 100.

Furthermore, FIG. 3 shows power limits P1 and P3 where P3 corresponds to the maximum power that may be applied to the wheel axle A1 and/or to the first wheel and where P1 corresponds to the maximum power that may be applied to the wheel axle A2 and/or to the second wheel during the current driving situation. The power limits P1 and P3 may be e.g., set by the road friction of the current road section. Moreover, FIG. 3 shows the maximum power P_{MAX} that may be delivered by electric machines powering the vehicle 100. In the example illustrated in FIG. 3, The wheels of the first axle A1 and/or the first wheel may e.g., be located on a high friction road surface and the power P_{A1} applied to the first vehicle axle A1 and/or to the first wheel, may thus be the maximum power P_{MAX} that might be generated by the at least one first electric machine 101a. The wheels of the second axle A2 and/or the second wheel may, on the other hand, be located on a low friction road surface which means that the power limit P1 is lower than the maximum power P_{MAX} that might be generated by the at least one second electric machine 101b. If power applied to a vehicle axle and/or wheel is higher than power limit P1, the vehicle wheels are likely to spin which may result in an instability situation and increased loss of energy.

Thus, as may be seen in FIG. 3 the total power P_{SUM} applied by the at least one first and the at least one second electric machine 101a, 101b between the time instance T0 and T1, is lower than P_{REQ} which means that during the current vehicle driving condition the vehicle cannot be operated according to the requirements. When such vehicle driving condition is detected, the invention performs a power transfer between the at least one first electric machine 101a and the at least one second electric machine 101b by means of a hydraulic connection. Thus, between the time instance T1 and the time instance T2, an additional power is generated by the at least one second electric machine 101b which additional power is transferred to the first vehicle axle A1 as shown in plot P_{A2}. This results in that the total power P_{SUM} is increased between the time instance T1 and T2. At the time instance T2 the sum of powers applied to the vehicle, inclusive the power transferred from the at least one second electric machine 101b to the at least one first electric machine 101a overcomes the total driving resistance and reaches the required minimum power P_{REQ}.

In other words, the invention may be applied in the vehicle 100 configured with two or more electric machines for propelling and/or braking the vehicle 100, wherein the two or more electric machines are interconnected by a hydraulic connection as will be explained further.

Such two or more electric machines may be configured in the vehicle 100 in different ways without limiting the scope of the invention. FIGS. 1b-1c show examples vehicle configurations comprising two or more electric machines, i.e., the at least one first electric machine 101a and the at least one second electric machine 101b.

The at least one first electric machine 101a is, as previously explained, configured to provide a power to a first vehicle wheel 111a and the at least one second electric machine 101b is configured to provide a propelling or a braking power to a second vehicle wheel.

FIG. 1b shows a vehicle configuration comprising a first electric machine 101a configured to provide a power to the vehicle wheel 111a, which is here the first vehicle wheel. The vehicle comprises moreover a second electric machine 101b configured to provide a power to a second vehicle wheel 111b, which is here the second vehicle wheel. In an embodiment, the first vehicle wheel 111a and the second vehicle wheel 111b may be located on a common vehicle axle A1 as shown in FIG. 1b. The first vehicle wheel 111a may, in an embodiment, be mechanically separated from the second vehicle wheel 111b.

In an embodiment, as illustrated in FIG. 1c, the first vehicle wheel 111a may instead be one or more wheels of a first vehicle axle A1 of the vehicle 100, and the second vehicle wheel 112a, 112b, may be one or more wheels of a second vehicle axle A2. The first vehicle axle A1 may, in an embodiment, be mechanically separated from the second vehicle axle A2.

In an embodiment, the at least one first electric machine 101a may be mechanically separated from the at least one second electric machine 101b.

As illustrated in FIGS. 1b-1c the at least one first electric machine 101a and the at least one second electric machine 101b may be interconnected by a hydraulic connection H. The hydraulic connection H may be used for power transfer between the interconnected electric machines. A hydraulic connection utilizes hydraulic fluid to transmit power from one electric machine to another. As illustrated in FIGS. 1b-1c, the hydraulic connection may comprise at least one hydraulic pump 109a, and at least one hydraulic motor 109b. In an embodiment, one or both of the at least one first and at least one second electric machine 101a, 101b may be configured to power the hydraulic pump 109a for providing hydraulic fluid to the hydraulic motor 109b connected to the wheel driven by the other of the at least one first and at least one second electric machine to thereby transfer power from the one of the at least one first and at least one second electric machine to the other.

In an embodiment, the at least one first electric machine 111a and/or the at least one second electric machine 111b may be configured to power a hydraulically connected PTO 130 as illustrated in FIGS. 1b-1c.

In addition to the method step 210 in FIG. 2a, the method 200 may, comprise optional steps 202-208 as shown in FIG. 2b. FIG. 2b shows thus a flow chart of the method 200 according to further embodiments of the invention. It should be noted that the method steps illustrated in FIG. 2b and described herein do not necessarily have to be executed in the order illustrated in FIG. 2b. The steps may essentially be executed in any suitable order, as long as the physical requirements and the information needed to execute each method step is available when the step is executed.

As previously explained, the method 200 of the invention is executed when at least one vehicle driving condition has been detected. Thus, in an optional step 202 in FIG. 2b preceding the previously described method step 210, the at least one driving condition resulting in the execution of the method 200 is detected.

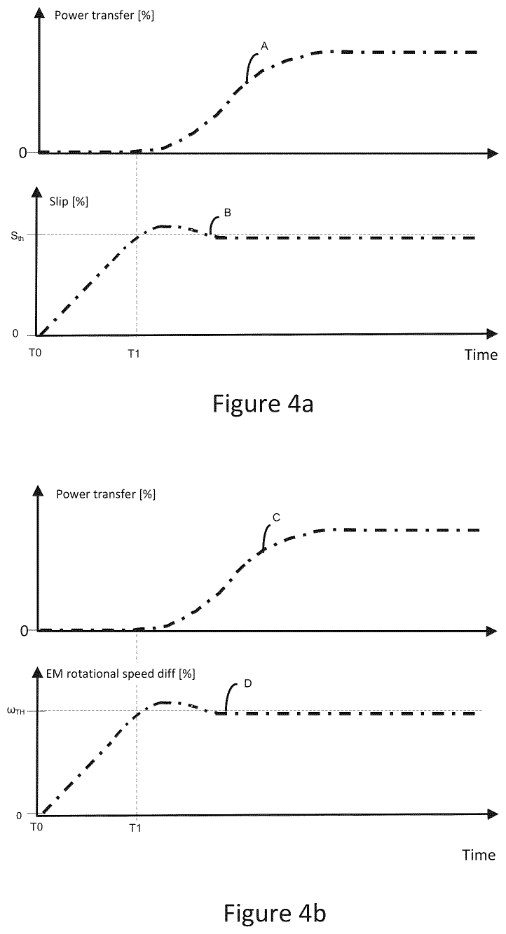

In an embodiment, the at least one vehicle driving condition resulting in the execution of the method 200 may occur when the grip of the first vehicle wheel 111a differs from the grip of the second vehicle wheel 111b, 112a, 112b. When such a vehicle driving condition is detected, the power may, in step 210, be transferred from the at least one first electric machine 101a to the at least one second electric machine 101b when the grip of the second vehicle wheel 111b exceeds the grip of the first vehicle wheel 111a, and vice versa. Such vehicle driving condition may be detected according to conventional methods, for example based on one or more parameters related to the vehicle driving condition which are described further on in this disclosure. Example of such power transfer based on a parameter related to the vehicle driving condition is shown in FIG. 4a and FIG. 4b.

The grip of the first vehicle wheel 111a being different from the grip of the second vehicle wheel 111b, 112a, 112b may be detected based on a wheel slip of the first vehicle wheel 111a and/or the second vehicle wheel 111b, 112a, 112b, as illustrated in FIG. 4a or on the rotational speed of the at least one first electric machine 101a and/or the at least one second electric machine 101b, as illustrated in FIG. 4b. For example, the power transfer may be performed when the difference in wheel slip ratio of the drive wheels or the difference in rotational speed of the electric machines reaches a certain threshold value. Such a difference in wheel slip ratio or electric machine rotational speed may for example occur when the friction of the road surface of the first vehicle wheel differs from the friction of the road surface of the second vehicle wheel. In another example, such a difference may occur when the load on the vehicle axles or the vehicle wheels becomes uneven. The load between vehicle axles or wheels may become uneven in several situations, including uneven load distribution, when the vehicle travels on inclined or uneven road surfaces, during braking and acceleration as well as when making turns. Moreover, the load between the vehicle axles or wheels may change when one or more axles are raised.

FIG. 4a shows the power transfer over time between two electric machines, such as the at least one first electric machine 101a and the at least one second electric machine 101b, based on the difference in wheel slip ratio of the drive wheels, such as the first vehicle wheel 111a and the second vehicle wheel 111b, 112a, 112b. As may be seen in the lower plot B in FIG. 4a, the difference between the wheel slip of the vehicle drive wheels increases between the time instance T0 and the time instance T1. At the time instance T1 the difference in the wheel slip reaches a slip threshold Sₜₕ. The magnitude of the slip threshold Sₜₕ may depend on the application of the invention and may be available in the control system of the vehicle 100. As illustrated in the upper plot A, between the time instance T0 and T1, i.e., when the difference in the vehicle slip is below the slip threshold Sₜₕ, no power transfer is performed between the at least one first electric machine 101a and the at least one second electric machine 101b. However, when the slip threshold Sₜₕ is reached, at the time instance T1, power is transferred from the at least one first electric machine 101a to the at least one second electric machine 101b when the grip of the second vehicle wheel 111b, 112a, 112b exceeds the grip of the first vehicle wheel 111a, and vice versa. The slip threshold Sₜₕ may, for example be a value larger than 0% and smaller than 10%.

In similar way, FIG. 4b shows a power transfer over time between two electric machines, such as the at least one first electric machine 101a and the at least one second electric machine 101b, based on the difference in rotational speed of the at least one first electric machine 101a and/or the at least one second electric machine 101b. It is to be understood that when determining if there is a difference in rotational speeds of the electric machines 101a, 101b, any difference in gear ratios applied to the at least one first electric machine 101a and the at least one second electric machine 101b needs to be taken into consideration. In case different gear ratios are applied to the electric machines 101a, 101b, the rotational speed of the at least one first electric machine 101a and/or the at least one second electric machine 101b needs to be compensated with the gear ratio difference before the difference in rotational speed is established.

As may be seen in the lower plot D in FIG. 4b, the difference between the rotational speed of the at least one first electric machine 101a and the at least one second electric machine 101b increases between the time instance T0 and the time instance T1. At the time instance T1 the difference between the rotational speed of the at least one first electric machine 101a and the at least one second electric machine 101b reaches a speed threshold ω_{TH}. The magnitude of the speed threshold ω_{TH} may depend on the application of the invention and may be available in the control system of the vehicle 100. As illustrated in the upper plot C, between the time instance T0 and T1, i.e., when the difference between the rotational speed of the at least one first electric machine 101a and the at least one second electric machine 101b is below the speed threshold ω_{TH}, no power transfer between the at least one first electric machine 101a and the at least one second electric machine 101b is performed. However, when the speed threshold ω_{TH} is reached, at the time instance T1, power is transferred from the at least one first electric machine 101a to the at least one second electric machine 101b when the grip of the second vehicle wheel 111b, 112a, 112b exceeds the grip of the first vehicle wheel 111a, and vice versa. The speed threshold ω_{TH} may, for example be a value larger than 0% and smaller than 10%.

By transferring the power between the vehicle wheels, the difference in the vehicle slip is kept below the slip threshold Sₜₕ and the applied power in the vehicle is increased. In an embodiment, when the at least one first electric machine 111a and/or the at least one second electric machine 111b is configured to power a hydraulically connected PTO 130, the vehicle driving condition may comprise a PTO power request. When such a PTO power request is detected, power from the at least one first electric machine 101a or the at least one second electric machine 101b may be transferred to the hydraulically connected PTO 130.

A PTO is used to transfer power from a power source such as an electric machine to another piece of equipment such as an auxiliary load consuming energy upon a power request. The PTO power request may relate to the activation of the PTO and may be manual, e.g., when the PTO is manually activated by the vehicle operator using a lever or a switch or automatic based on e.g., a control algorithm in the vehicle depending on the specific application. For example, when the auxiliary load is a compressor of a refrigerator unit, the PTO may be automatically activated based on a temperature of the refrigerator unit. Such PTO power request may be detected by or communicated to the control arrangement 120, according to conventional methods.

In step 204 in FIG. 2b, the magnitude of power to be transferred over the hydraulic connection is determined. In an embodiment, the magnitude of power transferred from the at least one first electric machine 101a and/or the at least one second electric machine 101b over the hydraulic connection may be based on one or more parameters related to the vehicle driving condition. The magnitude of power to be transferred over the hydraulic may, for example, be determined based on the power required to propel or brake the vehicle 100 on the approaching road section according to a required vehicle speed. The required vehicle speed may for example be based on a rate or a rate of change of an acceleration request. The power required to propel or brake the vehicle 100 on the approaching road section can be predicted based on Newtons laws of motion taking into consideration the forces acting upon the vehicle 100 in an approaching road section when being propelled according to the required speed. The forces may, according to conventional solutions, depend on parameters such as the vehicle weight, a vehicle steering angle, information related to the road condition of the coming road section, and road topology information such as the inclination of the approaching road section. Moreover, the magnitude of power to be transferred over the hydraulic connection may be based on the available power that may be transferred between the vehicle and the road, i.e., on the maximum power that may be delivered by the at least one first electric machine 101a and the at least one second electric machine 101b. Moreover, the power to be transferred over the hydraulic connection may be based on the vehicle drive mode.

When the power transferred over the hydraulic connection powers a hydraulically connected PTO, the magnitude of power to be transferred may be based on the power request to a PTO connected to the at least one first electric machine 101a and/or the at least one second electric machine 101b.

In other words, the parameters related to the vehicle driving condition may comprise vehicle internal parameters such as a rotational speed of the at least one first electric machine 101a and/or the at least one second electric machine 101b, a wheel slip of the first vehicle wheel 111a and/or the second vehicle wheel 111b, a weight of the vehicle 100, a rate or a rate of change of an acceleration request, an available power that may be transferred between the vehicle and the road, a vehicle drive mode, a vehicle steering angle, a load on the vehicle axles of the vehicle, and/or a power request to a PTO connected to the at least one first electric machine 101a and/or the at least one second electric machine 101b, as well as information related to the road section on which the vehicle is being operated such as an inclination of an approaching road section, and the road condition of the coming road section. Such parameters may be obtained in the vehicle 100 according to a number of known ways all included within the scope of the invention. Vehicle internal parameters be available in the vehicle's control system. The information related to the road section on which the vehicle is being operated may be obtained based on map data, e.g. from digital maps available in the vehicle 100 including e.g. topographical information, in combination with positioning information, e.g. GPS information. The positioning information may be used to determine the location of the vehicle 100 relative to the map data so that the road section information may be extracted from the map data. Moreover, such information may be detected by means of one or more sensors 140 which may be included in the vehicle 100 such as one or more camera or one or more radar. Moreover, such information may be obtained from at least one other vehicle in front the vehicle 100 and communicated, e.g., via the at least one communication device to the vehicle 100 using V2V communication.

In an optional step 206 in FIG. 2b, the at least one first electric machine 101a is disconnected from the first vehicle wheel 111a and/or the at least one second electric machine 101b from the second vehicle wheel 111b, 112a, 112b prior to transferring power from the disconnected electric machine over the hydraulic connection in step 210.

In an optional step 208 in FIG. 2b, the hydraulic pressure in the hydraulic connection is increased when power is to be transferred between the electric machines.

According to an aspect of the invention, a control arrangement 120 for powering a vehicle 100 is presented. The vehicle comprising at least one first electric machine 101 a configured to provide a power to a first vehicle wheel 111a, and at least one second electric machine 101b configured to provide a power to a second vehicle wheel 111b, 112a, 112b, wherein the at least one first electric machine 101a and the at least one second electric machine 101b are interconnected by means of a hydraulic connection, the control arrangement being configured to, for at least one vehicle driving condition:

The control arrangement 120 includes means 121 arranged to, for at least one vehicle driving condition, transfer 210 a power between the at least one first electric machine 101a and the at least one second electric machine 101b by means of the hydraulic connection.

The control arrangement 120, e.g. a device or a control device, according to the invention may be arranged for performing all of the above, in the claims, and in the herein described embodiments method steps. The control arrangement 120 is hereby provided with the above described advantages for each respective embodiment. The invention is also related to a vehicle 100 including the control arrangement 120.

Now turning to FIG. 5 which illustrates the control arrangement 500/120, which may correspond to or may include the above-mentioned control unit 121 as well as other control units performing the method steps of the disclosed invention. The control arrangement 500/120 comprises a computing unit 501, which can be constituted by essentially any suitable type of processor or microcomputer, e.g. a circuit for digital signal processing (Digital Signal Processor, DSP), or a circuit having a predetermined specific function (Application Specific Integrated Circuit, ASIC). The computing unit 501 is connected to a memory unit 502 arranged in the control arrangement 500/120, which memory unit provides the computing unit 501 with, e.g., the stored program code and/or the stored data which the computing unit 501 requires to be able to perform computations. The computing unit 501 is also arranged to store partial or final results of computations in the memory unit 502.

In addition, the control arrangement 500/120 is provided with devices 511, 512, 513, 514 for receiving and transmitting input and output signals. These input and output signals can contain waveforms, impulses, or other attributes which, by the devices 511, 513 for the reception of input signals, can be detected as information and can be converted into signals which can be processed by the computing unit 501. These signals are then made available to the computing unit 501. The devices 512, 514 for the transmission of output signals are arranged to convert signals received from the computing unit 501 in order to create output signals by, e.g., modulating the signals, which can be transmitted to other parts of and/or systems in the vehicle 100.

Each of the connections to the devices for receiving and transmitting input and output signals can be constituted by one or more of a cable; a data bus, such as a Controller Area Network CAN bus, a Media Orientated Systems Transport MOST bus, or some other bus configuration; or by a wireless connection. A person skilled in the art will appreciate that the above-stated computer can be constituted by the computing unit 501 and that the above-stated memory can be constituted by the memory unit 502.

Control systems in modern vehicles commonly comprise communication bus systems consisting of one or more communication buses for linking a number of electronic control units, ECU's, or controllers, and various components located on the vehicle. Such a control system can comprise a large number of control units and the responsibility for a specific function can be divided amongst more than one control unit. Vehicles of the shown type thus often comprise significantly more control units than are shown in FIGS. 1 and 5, which is well known to the person skilled in the art within this technical field.

In a shown embodiment, the invention may be implemented by the one or more above control units, such as the control unit 121. The invention can also, however, be implemented wholly or partially in one or more other control units already in the vehicle 100, or in some control unit dedicated to the invention.

Here and in this document, units are often described as being arranged for performing steps of the method according to the invention. This also includes that the units are designed to and/or configured to perform these method steps.

The control units used to implement the invention may be implemented as one control unit or be logically separated but physically implemented in the same unit or can be both logically and physically arranged together. These units may e.g. correspond to groups of instructions, which can be in the form of programming code, that are input into, and are utilized by a processor/computing unit 501 when the units are active and/or are utilized for performing its method steps, respectively.

The person skilled in the art will appreciate that the herein described embodiments for powering a vehicle 100 may also be implemented in a computer program, which, when it is executed in a computer, instructs the computer to execute the method. The computer program is usually constituted by a computer program product 503 stored on a non-transitory/non-volatile digital storage medium, in which the computer program is incorporated in the computer-readable medium of the computer program product. The computer-readable medium comprises a suitable memory, such as, e.g.: Read-Only Memory ROM, Programmable Read-Only Memory PROM, Erasable PROM EPROM, Flash memory, Electrically Erasable PROM EEPROM, a hard disk unit, etc.

The invention is not limited to the above described embodiments. Instead, the invention relates to, and encompasses all different embodiments being included within the scope of the independent claims.

1. A method for powering a vehicle, the vehicle comprising at least one first electric machine configured to provide a power to a first vehicle wheel, and at least one second electric machine configured to provide a power to a second vehicle wheel, wherein the at least one first electric machine and the at least one second electric machine are interconnected by means of a hydraulic connection, the method comprising, for at least one vehicle driving condition:
transferring a power between the at least one first electric machine and the at least one second electric machine by means of the hydraulic connection.

2. The method according to claim 1, wherein the vehicle driving condition occurs when the grip of the first vehicle wheel differs from the grip of the second vehicle wheel, the method further comprising:
transferring power from the at least one first electric machine to the at least one second electric machine when the grip of the second vehicle wheel exceeds the grip of the first vehicle wheel, and vice versa.

3. The method according to claim 1, wherein the first vehicle wheel and the second vehicle wheel are located on a common vehicle axle.

4. The method according to claim 1, wherein the first vehicle wheel is a wheel of a first vehicle axle of the vehicle, and the second vehicle wheel is a wheel of a second vehicle axle.

5. The method according to claim 4, wherein the first vehicle axle is mechanically separated from the second vehicle axle.

6. The method according to claim 1, wherein the at least one first electric machine is mechanically separated from the at least one second electric machine.

7. The method according to claim 1, wherein the at least one first electric machine and/or the at least one second electric machine is configured to power a Power Take-Off (PTO) by means of a hydraulic connection, and wherein the vehicle driving condition comprises a PTO power request, the method further comprising:
transferring power from the at least one first electric machine or the at least one second electric machine to the hydraulically connected PTO.

8. The method according to claim 1, wherein the magnitude of power transferred from the at least one first electric machine and/or the at least one second electric machine over the hydraulic connection is based on one or more parameters related to the vehicle driving condition.

9. The method according to claim 8, wherein the parameters related to the vehicle driving condition comprise one or more of:
a rotational speed of the at least one first electric machine and/or the at least one second electric machine,
a wheel slip of the first vehicle wheel and/or the second vehicle wheel,
a weight of the vehicle,
an inclination of an approaching road section,
a rate or a rate of change of an acceleration request,
an available power that may be transferred between the vehicle and the road,
a vehicle drive mode,
a road condition of the coming road section,
a vehicle steering angle,
a load on the vehicle axles of the vehicle, and/or
a power request to a PTO connected to the at least one first electric machine and/or the at least one second electric machine.

10. The method according to claim 1, further comprising:
disconnecting the at least one first electric machine from the first vehicle wheel and/or the at least one second electric machine from the second vehicle wheel prior to transferring power from the disconnected electric machine over the hydraulic connection.

11. The method according to claim 1, wherein one or both of the at least one first and at least one second electric machine is configured to power a hydraulic pump for providing hydraulic fluid to a hydraulic motor connected to the wheel driven by the other of the at least one first and at least one second electric machine to thereby transfer power from the one of the at least one first and at least one second electric machine to the other.

12. The method according to claim 10, wherein a hydraulic pressure in the hydraulic connection is increased when power is to be transferred between the electric machines.

13. A control arrangement for powering a vehicle, the vehicle comprising at least one first electric machine configured to provide a power to a first vehicle wheel, and at least one second electric machine configured to provide a power to a second vehicle wheel, wherein the at least one first electric machine and the at least one second electric machine are interconnected by means of a hydraulic connection, the control arrangement being configured to, for at least one vehicle driving condition:
transfer a power between the at least one first electric machine and the at least one second electric machine by means of the hydraulic connection.

14. A vehicle comprising:
at least one first electric machine configured to provide a power to a first vehicle wheel;
at least one second electric machine configured to provide a power to a second vehicle wheel, wherein the at least one first electric machine and the at least one second electric machine are interconnected by means of a hydraulic connection; and
a control arrangement configured to, for at least one vehicle driving condition, transfer a power between the at least one first electric machine and the at least one second electric machine by means of the hydraulic connection.

15. A computer program product comprising computer program code stored on a non-transitory computer-readable medium, said computer program code configured for powering a vehicle, the vehicle comprising at least one first electric machine configured to provide a power to a first vehicle wheel, and at least one second electric machine configured to provide a power to a second vehicle wheel, wherein the at least one first electric machine and the at least one second electric machine are interconnected by means of a hydraulic connection, said computer program code comprising instructions which, when executed by a control device, cause the control device to, for at least one vehicle driving condition:
transfer a power between the at least one first electric machine and the at least one second electric machine by means of the hydraulic connection.

16. (canceled)
